(19) United States
(12) Patent Application Publication
(10) Pub. No.: US 2007/0132244 A1
(43) Pub. Date: Jun. 14, 2007

(54) Flywheel for electric generating device

(75) Inventor: Kuo Hsun Chen, Taipei Hsien (TW)

Correspondence Address: CHARLES E. BAXLEY, ESQUIRE, SUITE 309, 90 JOHN STREET, NEW YORK, NY, 10038, US

(73) Assignee: Tai Feng Engineering Co., Ltd.

(21) Appl. No.: 11/304,951

(22) Filed: Dec. 14, 2005

(51) Int. Cl. F03G 7/08

(52) U.S. Cl. 290/1 R

(57) ABSTRACT

An electric generating device includes a rotatable shaft, an electric generator having one or more rotors coupled to and driven by the shaft, and one or more flywheels attached to the shaft and rotated in concert with the shaft, the flywheels each includes one or more weight members for increasing a moment of inertia to the flywheels and for facilitating a rotational movement of the flywheels and the shaft. It is preferable that the weight members are attached the outer peripheral portions of the flywheels. The weight members of the flywheels are angularly offset from each other for stabilizing the flywheels and the shaft.

### BACKGROUND OF THE INVENTION

1. Field of the Invention

The present invention relates to an electric generating device, and more particularly to an electric generating device having an improved flywheel having an increased momentum for facilitating the rotational movement of the flywheel and for facilitating the electric generating function or effect or capability of the electric generating device.

2. Description of the Prior Art

Various kinds of typical means or facilities or power sources have been used to generate electricity, and comprise such as water power, fire power, wind power, nuclear energy, solar energy, earth heat energy, ocean waves, magnetic forces, or fuel. Normally, one or more electric generators are required to be coupled to the typical means or facilities or power sources for being powered or driven by the typical means or facilities or power sources to generate electricity.

For example, U.S. Pat. No. 3,944,855 to Le Van discloses one of the typical methods and apparatuses for generating electricity by vehicle and pedestrian weight force and also comprising an electric generator coupled to and powered or driven by a movable segment of a roadway or traffic way over which either vehicles and/or pedestrian traffic flows. However, such kind of electric generators have no flywheel members for facilitating the electric generating capability of the electric generator.

U.S. Pat. No. 4,354,448 to Lin discloses another manually driven generating mechanism for doorbells and comprises a dynamo including a shaft rotated or driven by a spring-biased gearing device, and a flywheel attached to the shaft for facilitating the rotational movement or momentum of the flywheel and for facilitating the electric generating function or effect or capability of the electric generator.

However, the typical flywheel includes a planar or geometric configuration that includes a less momentum, such that the rotational movement or momentum of the flywheel may not be increased and such that the electric generating function or effect or capability of the electric generator may not be suitably facilitated or improved. When the typical flywheel includes a greatly increased volume or weight, it will take or spend a greater electric power or energy to rotate the shaft and thus may not suitably generate electrical energy.

The present invention has arisen to mitigate and/or obviate the afore-described disadvantages of the conventional flywheels for electric generators.

### SUMMARY OF THE INVENTION

The primary objective of the present invention is to provide an electric generating device including an improved flywheel having an increased momentum for facilitating the rotational movement of the flywheel and for facilitating the electric generating function or effect or capability of the electric generating device.

In accordance with one aspect of the invention, there is provided an electric generating device comprising a rotatable shaft, an electric generator including at least one rotor rotatably disposed therein and coupled to and driven by the shaft, and at least one flywheel attached to the shaft and rotated in concert with the shaft, the flywheel including at least one weight member attached thereto for increasing a moment of inertia to the flywheel and for facilitating a rotational movement of the flywheel and the shaft.

The flywheel includes an outer peripheral portion having the weight member attached thereto. The flywheel includes at least one cavity formed therein for receiving the weight member therein.

A second flywheel may further be provided and attached to the shaft and rotated in concert with the shaft, the second flywheel including at least one second weight member attached thereto for increasing a moment of inertia to the second flywheel and for facilitating a rotational movement of the second flywheel and the shaft.

The second flywheel includes an outer peripheral portion having the second weight member attached thereto. The second flywheel includes at least one cavity formed therein for receiving the second weight member therein. The second weight member of the second flywheel is angularly offset from the weight member of the flywheel.

A base may further be provided for rotatably supporting the shaft thereon. A motor may further be provided and coupled to the shaft for rotating and driving the shaft.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view of an electric generating device in accordance with the present invention;

FIG. 2 is a partial plan schematic view of the electric generating device;

FIG. 3 is a plan schematic view illustrating an electric circuit and/or the means or facilities or power sources for powering or driving the electric generating device;

FIG. 4 is a partial cross sectional view illustrating one of the flywheels of the electric generating device;

FIG. 5 is a partial cross sectional view illustrating another flywheel of the electric generating device;

FIGS. 6, 7 are partial cross sectional views similar to FIGS. 4 and 5 respectively, illustrating the other arrangement of the flywheels of the electric generating device; and

FIGS. 8, 9 are partial cross sectional views similar to FIGS. 4-5 and 6-7 respectively, illustrating the further arrangement of the flywheels of the electric generating device.

### DETAILED DESCRIPTION OF THE PREFERRED EMBODIMENT

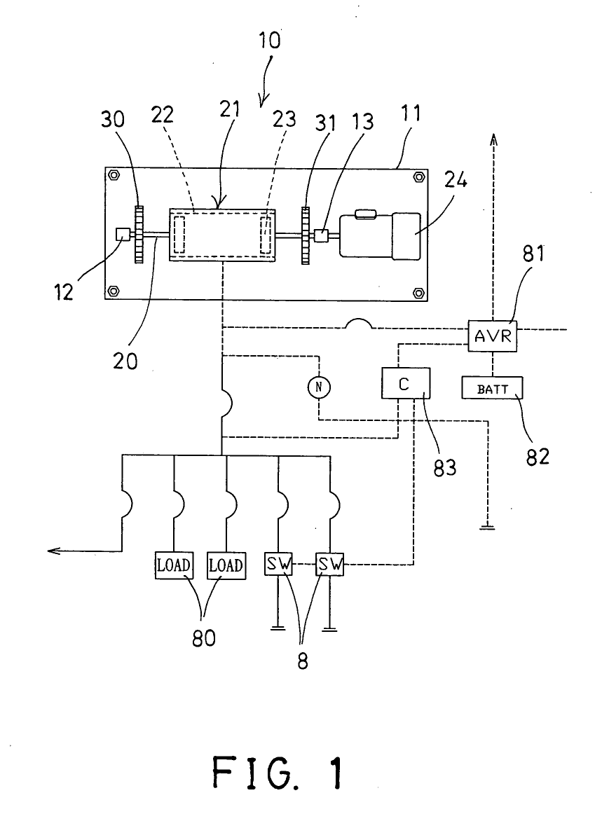

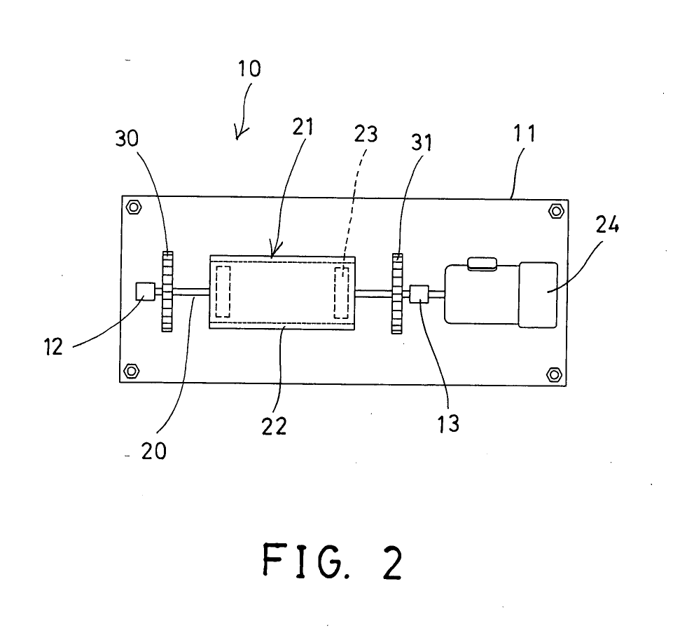

Referring to the drawings, and initially to FIGS. 1 and 2, an electric generating device 10 in accordance with the present invention comprises a base 11, such as a base plate 11 including one or more gaskets or bushes or bearing devices 12, 13 disposed thereon for rotatably supporting a shaft 20 thereon, an electric generator 21 disposed or supported on the base 11 and including one or more stators 22 disposed therein and one or more rotors 23 rotatably disposed therein and coupled to or rotated or driven by the shaft 20 for rotating relative to the stators 22 and for generating electricity.

A motor 24 may further be provided and coupled to the shaft 20 for rotating or driving the shaft 20. The electric generating device 10 may further include one or more flywheels 30, 31 attached or secured onto the shaft 20 and rotated in concert with the shaft 20, for increasing the moment of inertia for the shaft 20 and for driving the electric generator 21 and for generating electricity to energize such as one or more electric switches 8 (FIG. 1), or to power one or more loads 80, or the like. The above-identified configuration or structure is typical and will not be described in further details.

As shown in FIGS. 1 and 3, the electric generating device 10 may further include one or more automatic voltage regulators (AVR) 81, one or more batteries 82 and/or one or more capacitors 83 for collecting the electric energy, one or more uninterruptible power suppliers 84, 85, one or more stabilizers 86, one or more frequency regulators 87, and/or one or more AC/DC converters 88 provided therein and coupled to the electric generator 21 and/or the motor 24 for facilitating the electric generating and/or collecting functions or capabilities. A wind power 90, a solar energy 91, and/or a water power 92, or the like may be provided and coupled to the converters 88 for driving or powering the motor 24. However, the parts or members are not related to the present invention and will not be described in further details.

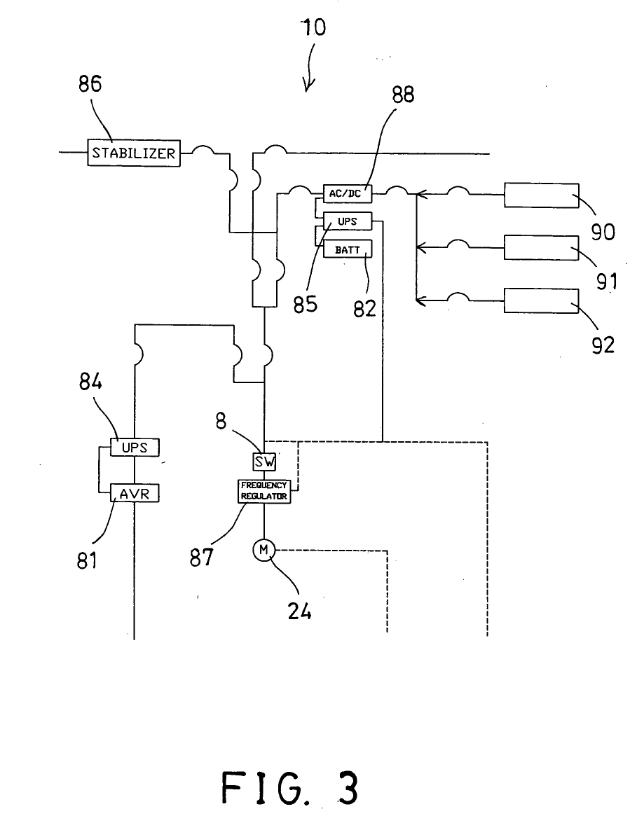

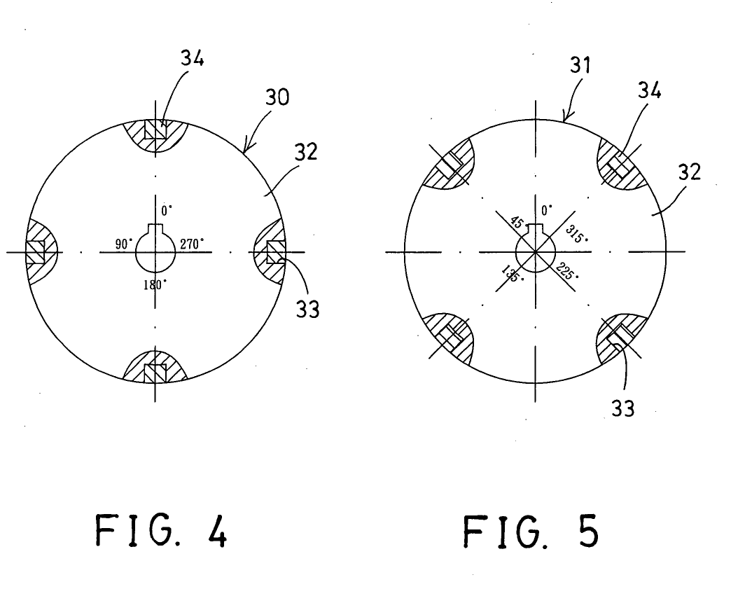

Referring next to FIGS. 4 and 5, the flywheels 30, 31 each includes an outer peripheral portion 32 having one, two, three or more orifices or cavities 33 formed therein each for receiving a weight member 34 therein, and for greatly increasing the moment of inertia to the flywheels 30, 31 and thus for facilitating the rotational movement of the flywheels 30, 31 and the shaft 20. For example, the flywheel 30 includes one, two, three or four weight members 34 evenly or uniformly attached to such as 0°, 90°, 180°, 270° of the outer peripheral portion 32 thereof, and the other flywheel 31 includes four weight members 34 evenly or uniformly attached to such as 45°, 135°, 225°, 315° of the outer peripheral portion 32 thereof and opposite to or angularly offset from the weight members 34 of the flywheel 30 for further increasing the moment of inertia to the shaft 20.

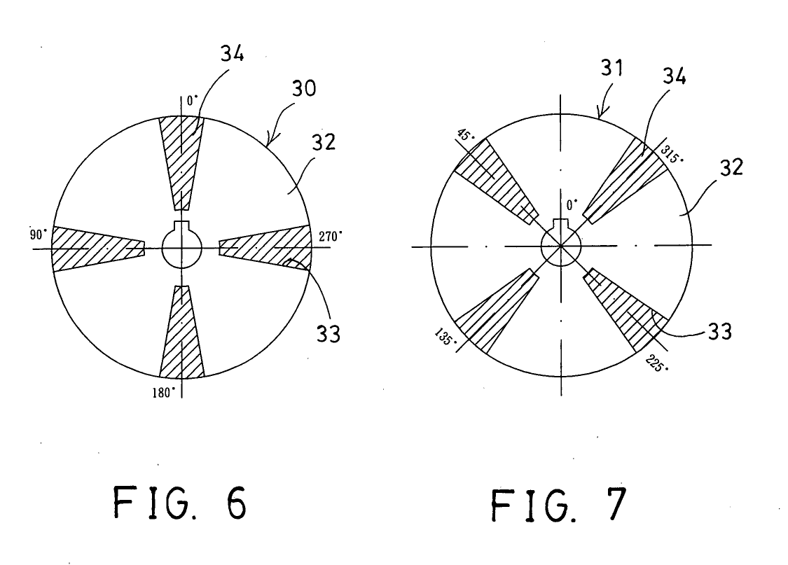

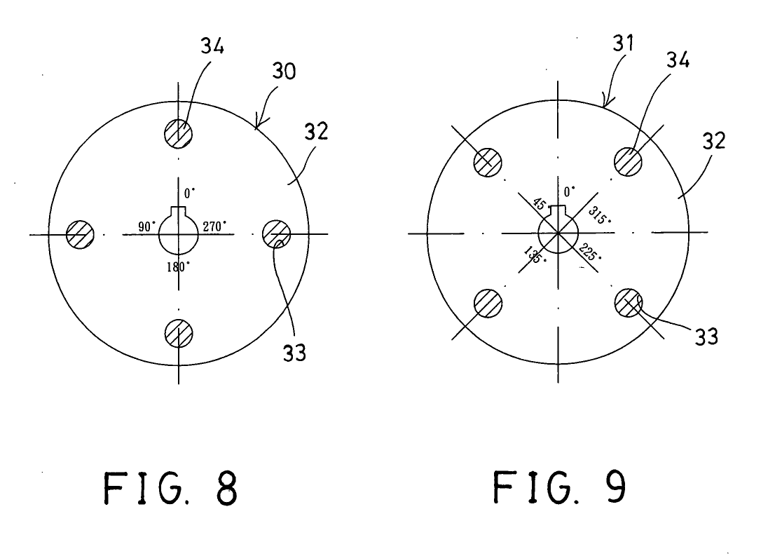

As shown in FIGS. 4-5, 6-7 and 8-9, the orifices or cavities 33 of the flywheels 30, 31 and the weight members 34 may be formed into various kinds of shapes, such as square or rectangular shape as shown in FIGS. 4-5, trapezoidal or sector shape as shown in FIGS. 6-7, or circular shape as shown in FIGS. 8-9, or other geometric shapes. Similarly, the weight members 34 are evenly or uniformly attached to the outer peripheral portion 32 of one of the flywheels 30 and opposite to or angularly offset from the weight members 34 of the other flywheel 31. The electric generating device 10 may include one or more pairs of the flywheels 30, 31 for suitably increasing the moment of inertia to the flywheels 30, 31 and the shaft 20.

Similarly, when the flywheel 30 includes one weight member 34 attached to such as the 0° of the outer peripheral portion 32 thereof, and the other flywheel 31 includes one weight member 34 preferably attached to such as 180° of the outer peripheral portion 32 thereof and opposite to or angularly offset from the weight member 34 of the flywheel 30 for increasing the moment of inertia to the shaft 20. However, it is preferable that each of the flywheels 30, 31 includes three or more weight members 34 evenly or uniformly attached to the outer peripheral portion 32 thereof for increasing the stability of the flywheels 30, 31 or for stabilizing the flywheels 30, 31.

In operation, when one or more pairs of the flywheels 30, 31 are attached onto the shaft 20, the shaft 20 and the flywheels 30, 31 may have a stabilized and increased rotational speed to cause or to drive or to power the electric generator 21 to suitably generate electricity. It is preferable that the flywheels 30, 31 are made of light weight materials, such as carbon fibers or glass fibers or other synthetic materials for decreasing the weight of the flywheels 30, 31, and the weight members 34 are made of heavy weight materials, such as metal, alloy or the combination thereof, or the like, for increasing the moment of inertia of the flywheels 30, 31.

Accordingly, the electric generating device includes a flywheel having an increased momentum for facilitating the rotational movement of the flywheel and for facilitating the electric generating function or effect or capability of the electric generating device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An electric generating device comprising:
a rotatable shaft,
an electric generator including at least one rotor rotatably disposed therein and coupled to and driven by said shaft, and
at least one flywheel attached to said shaft and rotated in concert with said shaft, said at least one flywheel including at least one weight member attached thereto for increasing a moment of inertia to said at least one flywheel and for facilitating a rotational movement of said at least one flywheel and said shaft.

2. The electric generating device as claimed in claim 1, wherein said at least one flywheel includes an outer peripheral portion having said at least one weight member attached thereto.

3. The electric generating device as claimed in claim 1, wherein said at least one flywheel includes at least one cavity formed therein for receiving said at least one weight member therein.

4. The electric generating device as claimed in claim 1 further comprising a second flywheel attached to said shaft and rotated in concert with said shaft, said second flywheel including at least one second weight member attached thereto for increasing a moment of inertia to said second flywheel and for facilitating a rotational movement of said second flywheel and said shaft.

5. The electric generating device as claimed in claim 4, wherein said second flywheel includes an outer peripheral portion having said at least one second weight member attached thereto.

6. The electric generating device as claimed in claim 4, wherein said second flywheel includes at least one cavity formed therein for receiving said at least one second weight member therein.

7. The electric generating device as claimed in claim 4, wherein said at least one second weight member of said second flywheel is angularly offset from said at least one weight member of said at least one flywheel.

8. The electric generating device as claimed in claim 1 further comprising a base for rotatably supporting said shaft thereon.

9. The electric generating device as claimed in claim 1 further comprising a motor coupled to said shaft for rotating and driving said shaft.
